(19) United States
(12) Patent Application Publication
(10) Pub. No.: US 2018/0204255 A1
(43) Pub. Date: Jul. 19, 2018

(54) METHOD AND DEVICE FOR RAPID SHOPPING

(71) Applicant: FANTEM TECHNOLOGIES (SHENZHEN) CO., LTD., Shenzhen, Guangdong (CN)

(72) Inventors: Winston CHENG, Shenzhen, Guangdong (CN); Jianhui LI, Shenzhen, Guangdong (CN); Zhen ZHANG, Shenzhen, Guangdong (CN); Yiwei ZHU, Shenzhen, Guangdong (CN); Haibin LUO, Shenzhen, Guangdong (CN); Hao ZHAN, Shenzhen, Guangdong (CN)

(21) Appl. No.: 15/577,095

(22) PCT Filed: Mar. 24, 2016
(86) PCT No.: PCT/CN2016/077196

§ 371 Date: Nov. 27, 2017

(30) Foreign Application Priority Data
May 27, 2015 (CN) 201510278417.9

(51) Int. Cl. G06Q 30/06; G06K 7/10

(52) U.S. Cl. CPC G06Q 30/0601; G06Q 30/0635; G06K 7/10297

(57) ABSTRACT

A method and device for rapid shopping are applicable to the field of an internet of things. The method includes: touching an NFC label and reading data content of the NFC label by a smart terminal (S101); parsing the data content of the NFC label and initiating a shopping scene according to a parsing result by the smart terminal (S102); and receiving a shopping selection and processing a shopping order according to a final result of the shopping selection by the smart terminal (S103). The method rapidly initiates a shopping scene and completes shopping of related commodity by means of a smart terminal.

### FIELD OF THE INVENTION

The present application relates to the technical field of an internet of things, and more particularly relates to method and device for rapid shopping.

### BACKGROUND OF THE INVENTION

Compared with Bluetooth, infrared and other wireless technologies, near field communication (NFC) enables electronic payments and reading of other NFC devices or labeling information. A short-range interaction of the NFC greatly simplifies an entire authenticated process and enables electronic devices to access each other faster and more securely. A plurality of electronic devices, for example a computer, a digital camera, a mobile phone, a PDA, and the like can be easily and quickly wirelessly connected by the NFC, and thereby realize data services.

NFC technology combines an inductive card reader, an inductive card, and point to point functions on a single chip. Like Radio Frequency Identification (RFID), the NFC technology identifies and exchanges data with a compatible device within a short distance by electromagnetic induction coupling of part of the radio frequency within the frequency spectrum.

An NFC mobile phone is a mobile phone with NFC function, which has a built-in smart security chip when shipped from a factory. It can apply for and download a bank card directly from the mobile phone without replacing a SIM card or other hardware to achieve near-field contactless payment and remote payment. With a rapid development of electronic and communication technologies, it is possible to use the mobile phone for shopping.

### SUMMARY OF THE INVENTION

A purpose of the invention is to provide method and device for rapid shopping, which are intended to rapidly initiate a shopping scene and complete shopping of a related commodity by a smart terminal.

An embodiment of the present application provides the following technical solution: a method for rapid shopping, including:

touching an NFC label and reading data content of the NFC label by a smart terminal;

parsing the data content of the NFC label and initiating a shopping scene by the smart terminal according to a parsing result; and

receiving a shopping selection and processing a shopping order by the smart terminal according to a final result of the shopping selection.

Furthermore, before the step of touching the NFC label and reading the data content of the NFC label by the smart terminal, the method further includes: setting the shopping scene corresponding to the NFC label.

Furthermore, after the step of setting the shopping scene corresponding to the NFC label, the method further includes: saving the shopping scene corresponding to the NFC label.

Furthermore, the step of initiating the shopping scene by the smart terminal according to the parsing result includes:

displaying an application supporting the NFC labels according to the parsing result; and

receiving the application selected by a user, and initiating the shopping scene according to the selected application.

Furthermore, after the step of receiving the shopping selection by the smart terminal, the method further includes:

selecting a shopping option content according to the shopping selection, and saving the shopping option content.

Furthermore, the step of processing the shopping order according to the final result of the shopping selection includes:

indicating optional commodity service providers according to the final result of the shopping selection; and

processing the shopping order according to the optional commodity service providers.

An embodiment of the present application provides the following technical solution: a device for rapid shopping, including:

a reading unit configured for a smart terminal to touch an NFC label and read data content of the NFC label;

a parsing unit configured for the smart terminal to parse the data content of the NFC label, and initiate a shopping scene according to a parsing result; and

a shopping unit, configured for the smart terminal to receive a shopping selection, and process a shopping order according to a final result of the shopping selection.

Furthermore, the device further includes a scene setting unit configured for setting the shopping scene corresponding to the NFC label.

Furthermore, the device further includes a scene saving unit configured for saving the shopping scene corresponding to the NFC label.

Furthermore, the parsing unit includes:

a parsing displaying unit, configured for displaying applications supporting the NFC labels according to the parsing result; and

a parsing initiating unit, configured for receiving the applications selected by a user, and initiating the shopping scene according to the selected application.

Furthermore, the device further includes a shopping option saving unit, configured for selecting a shopping option content according to the shopping selection, and saving the shopping option content.

Furthermore, the shopping unit includes:

a shopping selecting unit, configured for indicating optional commodity service providers according to the final result of the shopping selection; and

an order processing unit, configured for processing a shopping order according to the optional commodity service providers.

In the embodiment of the present application, a smart terminal touches an NFC label and reads data content of the NFC label; then initiates a corresponding shopping scene according to the data content of the NFC label, a rapid shopping selection can be conveniently implemented by using the shopping scene, and finally rapidly completes shopping of the related commodity within the shopping scene. The smart terminal further processes a follow-up shopping order according to a user's selection, so it is convenient for the user to rapidly procure the commodity according to an actual need, and a pertinence of application scene and a convenience of usage are improved.

### BRIEF DESCRIPTION OF THE DRAWINGS

FIG. 1 is an implementation flowchart of a method for rapid shopping provided by a first embodiment of the present application.

FIG. 2 is an implementation flowchart of a method for rapid shopping provided by a second embodiment of the present application.

FIG. 3 is a structural diagram of a device for rapid shopping provided by a third embodiment of the present application.

FIG. 4 is a structural diagram of a device for rapid shopping provided by a fourth embodiment of the present application.

### DETAILED DESCRIPTION OF THE PREFERRED EMBODIMENTS

In order to make those skilled in the art better understand the technical solutions of the present application, the technical solutions of the embodiments of the present application will be further described in detail hereinafter with reference to accompanying drawings in the embodiments of the present application. Apparently, the described embodiments are merely a part of the embodiments of the present application, but not all of the embodiments. All other embodiments obtained by those skilled in the art based on the embodiments of the present application without creative efforts shall fall within the protecting scope of the present application.

The terms “first”, “second”, “third”, “fourth”, etc. (if present) in the description and claims of the present application, and the above accompanying drawings are used to distinguish similar objects and do not have to be used describe a specific order or sequence. It should be understood that the used data may be interchanged, where appropriate, so that the embodiments described herein can be implemented in an order other than what is illustrated or described herein. Furthermore, terms “include”, “have”, and any variations thereof are intended to cover a non-exclusive inclusion, for example, including a process, method, system, product, or apparatus of a series of steps or units, which is not necessarily limited to those steps or units that are expressly listed, but may include other steps or units not expressly listed or inherent to these processes, methods, products, or devices.

The specific implementation of the present application is described in detail hereinafter with reference to the specific embodiments.

### Example 1

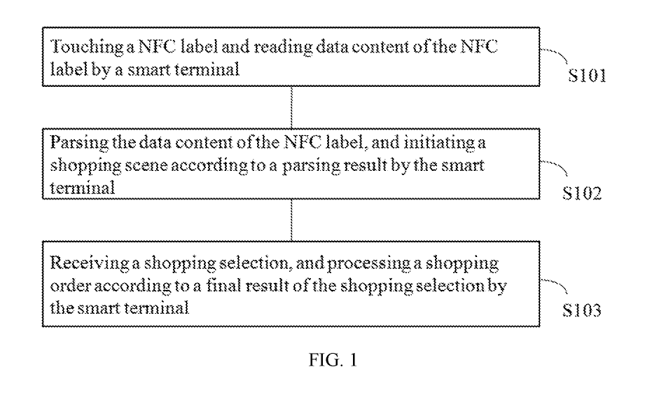

FIG. 1 shows a flow for implementing a method for rapid shopping provided by a first embodiment of the present application, which is described in detail as follows:

At block S101, touching an NFC label and reading data content of the NFC label by a smart terminal.

In a specific process of its implementation, when a user needs shopping, a specific application scene can be, when the user turns on, such as a refrigerator, and finds that one or more types of products in the refrigerator have little or no product left, which the user needs purchase at the moment. Thus, the user can make the smart terminal to touch the NFC label, and the smart terminal can read the data content of the NFC label when the smart terminal touches the NFC label.

At block S102, parsing the data content of the NFC label, and initiating a shopping scene according to a parsing result by the smart terminal.

In this embodiment of the present application, after the user reading the data content of the NFC label by the smart terminal, the smart terminal parses the data according to the read data content. The shopping scene, which needs to be initiated by the smart terminal, is obtained by parsing the data content in the NFC label. Then the corresponding shopping scene is initiated according to the parsing result, of which the shopping scene can be initiated by an application program or initiated by a specific network connection address.

At block S103, receiving a shopping selection, and processing a shopping order according to a final result of the shopping selection by the smart terminal.

In this embodiment of the present application, after the smart terminal initiating the corresponding shopping scene according to the parsing result, for example, at the moment, the user touches the NFC label of the refrigerator, and initiates the rapid shopping scene of the refrigerator after reading and successfully parsing the label; a corresponding product can be selected according to a shopping option of the shopping scene of the refrigerator; for example, the user selects products such as milk and eggs in the shopping option according to the shopping scene of the refrigerator; the shopping option is completed on the smart terminal after the user determines a final purchased product, and relevant address selection, payment selection and mailing time selection are completed under a specific usage. The smart terminal receives the user's final shopping selection, and processes the shopping order according to the user's selection. After processing the shopping order, an optional smart terminal may also feedback processing information of the shopping order and the other subsequent processing information to the user.

In the above method of the embodiment of the present application, a method for rapid shopping is provided. A smart terminal touches an NFC label and reads data content of the NFC label; then initiates a corresponding shopping scene according to the data content of the NFC label; a rapid shopping selection can be conveniently implemented by using the shopping scene; and finally rapidly completes shopping of the related commodity within the shopping scene. The smart terminal further processes a follow-up shopping order according to a user's selection, so it is convenient for the user to rapidly procure the commodity according to actual needs, and thereby a pertinence of application scene and a convenience of use are improved.

### Example 2

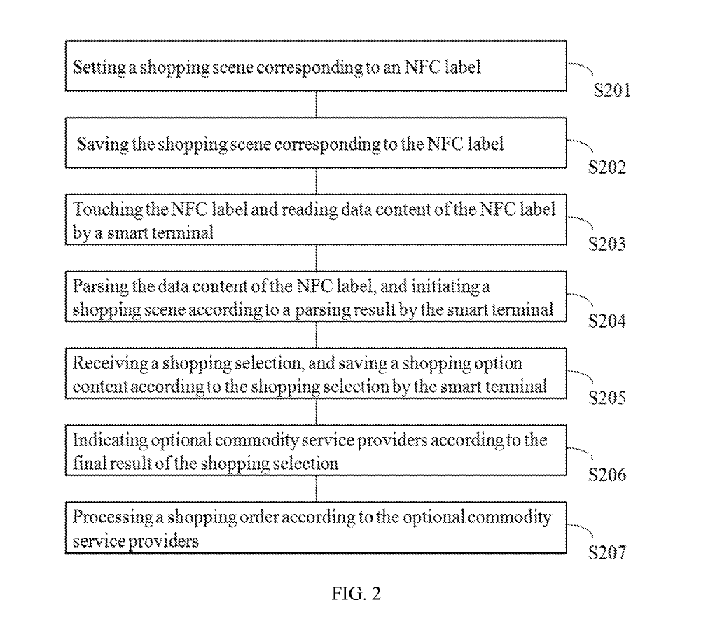

FIG. 2 shows a flow for implementing a method for rapid shopping provided by a second embodiment of the present application, which is described in detail as follows:

At block S201, setting a shopping scene corresponding to an NFC label.

In the embodiment of the present application, since the new NFC label can be a blank label, when a user needs to use the NFC label for rapid shopping, the new blank label may first be set for the shopping scene by the user. For example, the shopping scene used cooperatively with and corresponding to the NFC label may be set by the user according to different application scenes, such as a washing machine, a refrigerator, or a study room. For example, a product required for a washing machine is usually a washing liquid and the like, thus the washing liquid purchase may be set for the shopping scene. Commodities purchased for the refrigerators are fresh vegetables, all kinds of food and beverage, and the like, thus the food purchase may be set for the shopping scene. Books are purchased for the study room, thus the books purchase may be set for the shopping scene. The user can make a customized setting according to specific usage requirement and environment, of which the setting of the NFC label may be that the user reads an identify number of the NFC label by an NFC reading device, then sets the corresponding shopping scene according to the unique identify number of the NCF label. While setting the shopping scene, the user can also select from a few options of common commodities in shopping scene. For example, under the shopping scene of the refrigerator, you can select some fast moving consumer goods, such as milk as the shopping scene in this scene.

At block S202, saving the shopping scene corresponding to the NFC label.

In this embodiment of the present application, after the user completes setting of the shopping scene of the NFC label, the user may save the setting results. When the user uses the smart terminal for the setting, the smart terminal can automatically save the setting content, of which the label content can be saved in, according to a specific usage, different places, such as the NFC label, the smart terminal, or a server. The shopping scene corresponding to the NFC table may be stored in the server by the smart terminal. The server may be a remote server, like as a cloud server, or a home-based server, like as gateways and other equipments. If necessary, the label content may also be saved by a co-existent method in various saving modes, for example, it can be saved simultaneously in the smart terminal and the server. The saving mode of different shopping scenes may be selected according to the different shopping scenes required for the user, and the scene content is finally saved by an appropriate mode. The shopping scene corresponding to the NFC label is preferably saved in the server, thus even if the user replaces the smart terminal device, as long as the user reads the NFC label already set, and thereby it can correctly parses the shopping scene consistent with the setting content.

At block S203, touching the NFC label and reading data content of the NFC label by a smart terminal.

In the embodiment of the present application, when the user needs shopping, the specific application scene may be that when the user turns on a refrigerator and finds that one or more types of products in the refrigerator have little or no product left, at the moment, the user can make the smart terminal to touch the NFC label, and the smart terminal can read the data content of the NFC label when the smart terminal touches the NFC label.

At block S204, parsing the data content of the NFC label, and initiating a shopping scene according to a parsing result by the smart terminal.

In the embodiment of the present application, after the user read the data content in the NFC label by the smart terminal, the smart terminal parses the data according to the reading data content. The smart terminal may store a plurality of application programs for initiating the shopping scene. For example, the shopping scene may be initiated by a browser or a shopping application program, at the same time, the smart terminal may display an application supporting the NFC labels according to the parsed result, such as the browser, the shopping application program, or a paying application program, and then the user may select an application required by the user according to the application displayed on the smart terminal. The smart terminal initiates the corresponding application and the shopping scene, after the smart terminal received the application selected by the user. When only one application of the smart terminal can initiate the shopping scene, the user does not need to select the required application but directly initiate the application. When a plurality of applications can initiate the shopping scene, the user may also set a default startup application, the shopping scene may be initiated directly by the default application after setting the default startup application. Because the NFC label has set the shopping scene corresponding to the NFC label in advance, and the shopping scene corresponding to the NFC label has different saving mode, so the NFC label can be parsed by different modes in different saving modes to obtain the shopping scene corresponding to the NFC label. When the shopping scene corresponding to the NFC label is saved in the server, the smart terminal parsing the data content of the NFC label can be that the shopping scene corresponding to the NFC label set in the server may be queried according to the identify number of the NFC label, and then initiates the shopping scene by the corresponding shopping scene saved in the server. When the shopping scene corresponding to the NFC label saved in the smart terminal or the NFC label, it can be parsed and initiated directly, of which the shopping scene can be initiated by an application program or initiated by opening a specific network connection address.

At block S205, receiving a shopping selection, and saving a shopping option content according to the shopping selection by the smart terminal.

In the embodiment of the present application, after the smart terminal initiating the corresponding shopping scene according to the parsed result, the user touches the NFC label of the refrigerator, and then initiates the rapid shopping scene of the refrigerator after read and parsed the NFC label successfully. At the same time, the user can select the corresponding product according to the shopping scene of the refrigerator. For example, the user may select 5 L of milk, 10 eggs, and 10 bottles of beer in the shopping option according to the shopping scene of the refrigerator. When the user selects these commodities, it may prompts the user to save the indication, and indicate the user to set a milk option, an egg option and a beer option as the rapid shopping menu option under the shopping scene of the refrigerator. When the user agrees to set the rapid shopping menu option, the shopping option content is saved. When the rapid shopping scene of the refrigerator is initiated next time, the milk option, the egg option and the beer option are automatically loaded in an options menu, so it may be convenient for the user to make the faster shopping selection. When the user selects the setting option of the rapid shopping menu, the smart terminal automatically and simultaneously saves the specific content of the shopping options. The saving mode may be saved in the NFC label, the smart terminal, or the server saving the shopping scene corresponding to the NFC label by the smart terminal, and thus the shopping option content is synchronously saved to facilitate the convenience for the user to use next time.

At block S206, indicating optional commodity service providers according to the final result of the shopping selection.

In the embodiment of the present application, after the user determined a final purchased commodity, the smart terminal completes a confirmation of the shopping selection. At the moment, the smart terminal indicates a subsequent related operation after the shopping selection. For example, the user selects 5 L of milk, 10 eggs, and 10 beers, because the prices, sales, user ratings, shopping discounts and delivery speed of different products in different shopping channels are different, so these information directly affecting a user's decision when purchasing the products may be integrated to display. These information are integrated to display, facilitate the shopping selection made by the user according to these information, and a final selection of the commodity service provider. For example, the optional commodity service providers, such as Jingdong, No. 1 stores, other e-commerce shopping channels, or shopping channels of other physical supermarkets, may be indicated respectively according to the user's selected product. Different shopping channels may display the product prices, sales volume, user ratings, shopping discounts, and delivery speed, and then the user selects the corresponding subsequent operation according to the relevant shopping channels.

At block S207, processing a shopping order according to the optional commodity service providers.

In the embodiment of the present application, after determining the optional commodity service providers, the user may complete an address selection, a payment selection, a mailing time selection, and the like under a specific usage. A plurality of default harvest address may be set for the address selection. Different payment platforms and payment channels may be selected for the payment selection. Preferably, the user needs to enter a payment password when the payment is confirmed. The payment password can protect user's financial security, and it can avoid misoperation resulting in unnecessary economic loss. The smart terminal receives the user's final shopping selection and processes an order according to the user's selection. The alternative smart terminal, after processing the order, may be feedback the processing information of the shopping order and the other subsequent processing information to the user.

In the above method of the embodiment of the present application, a method for rapid shopping is provided as follows: setting a shopping scene corresponding to an NFC label, firstly; then a smart terminal touches the NFC label and reads data content of the NFC label; and then initiates the corresponding shopping scene according to the data content of the NFC label. A rapid shopping selection can be conveniently implemented by using the shopping scene and the shopping option, and finally rapidly completes the purchase of the desired product within the shopping scene; and then the smart terminal processes a follow-up shopping order according to a user's selection, so it is convenient for the user to rapidly procure the commodities according to actual needs. Because of the shopping scene corresponding to the NFC label may be set according to the user's specific usage. The specific shopping option may be a personalized setting based on a user's shopping history, which can greatly facilitate the rapid procurement of a specific commodity for the user under next usage, an improvement of shopping efficiency, but also great convenience for users.

### Example 3

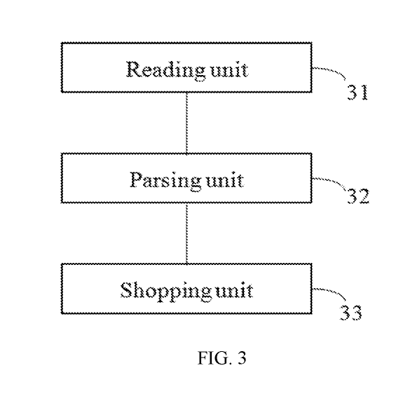

FIG. 3 shows a structural view of a device for rapid shopping provided by a third embodiment of the present application. For illustration purposes, only parts related to the embodiments of the present application are shown.

A reading unit 31, which is configured for touching an NFC label and read data content of the NFC label by a smart terminal.

In the embodiment of the present application, the reading unit is configured that when a user needs shopping, a specific application scene can be, when the user turns on, such as a refrigerator, and finds that one or more types of products in the refrigerator have little or no product left, which the user needs purchase at the moment. Thus, the user can make the smart terminal touch the NFC label, and the smart terminal can read the data content of the NFC label when the smart terminal touches the NFC label.

A parsing unit 32, which is configured for parsing the data content of the NFC label, and initiating a shopping scene according to the resolution result by the smart terminal.

In the embodiment of the present application, the parsing unit is configured that, after the user reading the data content of the NFC label by the smart terminal, the smart terminal parses the data according to the read data content. The shopping scene, which needs to be initiated by the smart terminal, is obtained by parsing the data content in the NFC label. Then the corresponding shopping scene is initiated according to the parsing result, of which the shopping scene can be initiated by an application program or initiated by a specific network connection address.

A shopping unit 33, which is configured for receiving a shopping selection, and processing a shopping order according to a final result of the shopping selection by the smart terminal.

In the embodiment of the present application, the shopping unit is configures that, after the smart terminal initiating the corresponding shopping scene according to the parsing result, for example, at the moment, the user touches the NFC label of the refrigerator, and initiates the rapid shopping scene of the refrigerator after reading and successfully parsing the label; a corresponding product can be selected according to a shopping option of the shopping scene of the refrigerator; for example, the user selects products such as milk and eggs in the shopping option according to the shopping scene of the refrigerator; the shopping option is completed on the smart terminal after the user determines a final purchased product, and relevant address selection, payment selection and mailing time selection are completed under a specific usage. The smart terminal receives the user's final shopping selection, and processes the shopping order according to the user's selection. After processing the shopping order, an optional smart terminal may also feedback processing information of the shopping order and the other subsequent processing information to the user.

In the above method of the embodiment of the present application, a device for rapid shopping is provided. A smart terminal touches an NFC label and reads data content of the NFC label; then initiates a corresponding shopping scene according to the data content of the NFC label, a rapid shopping selection can be conveniently implemented by using the shopping scene, and finally rapidly completes shopping of the related commodity within the shopping scene. The smart terminal further processes a follow-up shopping order according to a user's selection, so it is convenient for the user to rapidly procure the commodity according to actual needs, and a pertinence of application scene and a convenience of use are improved.

### Example 4

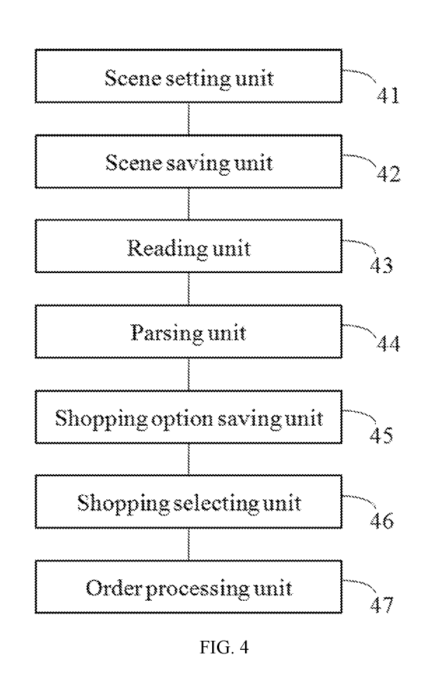

FIG. 4 shows a structural view of a device for rapid shopping provided by a fourth embodiment of the present application. For illustration purposes, only parts related to the embodiments of the present application are shown.

A scene setting unit 41, which is configured for setting a shopping scene corresponding to an NFC label.

In the embodiment of the present application, since the new NFC label may be a blank label, the scene setting unit is configured that, when a user needs to use the NFC label for rapid shopping, the new blank label may first be set for the shopping scene by the user. For example, the shopping scene used cooperatively with and corresponding to the NFC label may be set by the user according to different application scenes, such as a washing machine, a refrigerator, or a study room. For example, a product required for a washing machine is usually a washing liquid and the like, thus the washing liquid purchase may be set for the shopping scene. Commodities purchased for the refrigerators are fresh vegetables, all kinds of food and beverage, and the like, thus the food purchase may be set for the shopping scene. Books are purchased for the study room, thus the books purchase may be set for the shopping scene. The user can make a customized setting according to specific usage requirement and environment, of which the setting of the NFC label may be that the user reads an identify number of the NFC label by an NFC reading device, then sets the corresponding shopping scene according to the unique identify number of the NCF label. While setting the shopping scene, the user can also select from a few options of common commodities in shopping scene. For example, under the shopping scene of the refrigerator, you can select some fast moving consumer goods, such as milk as the shopping scene in this scene.

A scene saving unit 42, which is configured for saving the shopping scene corresponding to the NFC label.

In the embodiment of the present application, the scene saving unit is configured that, after the user completes setting of the shopping scene of the NFC label, the user may save the setting results. When the user uses the smart terminal for the setting, the smart terminal can automatically save the setting content, of which the label content can be saved in, according to a specific usage, different places, such as the NFC label, the smart terminal, or a server. The shopping scene corresponding to the NFC table may be stored in the server by the smart terminal. The server may be a remote server, like as a cloud server, or a home-based server, like as gateways and other equipments. If necessary, the label content may also be saved by a co-existent method in various saving modes, for example, it can be saved simultaneously in the smart terminal and the server. The saving mode of different shopping scenes may be selected according to the different shopping scenes required for the user, and the scene content is finally saved by an appropriate mode. The shopping scene corresponding to the NFC label is preferably saved in the server, thus even if the user replaces the smart terminal device, as long as the user reads the NFC label already set, and thereby it can correctly parses the shopping scene consistent with the setting content.

A reading unit 43, which is configured for touching the NFC label and reading data content of the NFC label by a smart terminal.

In the embodiment of the present application, the reading unit 43 is configured that, when the user needs shopping, the specific application scene may be that when the user turns on a refrigerator and finds that one or more types of products in the refrigerator have little or no product left, at the moment, the user can make the smart terminal touch the NFC label, and the smart terminal can read the data content of the NFC label when the smart terminal touches the NFC label.

A parsing unit 44, which is configured for parsing the data content of the NFC label, and initiating a shopping scene according to a parsing result by the smart terminal.

In the embodiment of the present application, the parsing unit is configured that, after the user read the data content in the NFC label by the smart terminal, the smart terminal parses the data according to the reading data content. The smart terminal may store a plurality of application programs for initiating the shopping scene. For example, the shopping scene may be initiated by a browser or a shopping application program, at the same time, the smart terminal may display an application supporting the NFC labels according to the parsed result, such as the browser, the shopping application program, or a paying application program, and then the user may select an application required by the user according to the application displayed on the smart terminal. The smart terminal initiates the corresponding application and the shopping scene, after the smart terminal received the application selected by the user. When only one application of the smart terminal can initiate the shopping scene, the user does not need to select the required application but directly initiate the application. When a plurality of applications can initiate the shopping scene, the user may also set a default startup application, the shopping scene may be initiated directly by the default application after setting the default startup application. Because the NFC label has set the shopping scene corresponding to the NFC label in advance, and the shopping scene corresponding to the NFC label has different saving mode, so the NFC label can be parsed by different modes in different saving modes to obtain the shopping scene corresponding to the NFC label. When the shopping scene corresponding to the NFC label is saved in the server, the smart terminal parsing the data content of the NFC label can be that the shopping scene corresponding to the NFC label set in the server may be queried according to the identify number of the NFC label, and then initiates the shopping scene by the corresponding shopping scene saved in the server. When the shopping scene corresponding to the NFC label saved in the smart terminal or the NFC label, it can be parsed and initiated directly, of which the shopping scene can be initiated by an application program or initiated by opening a specific network connection address.

A shopping option saving unit 45, which is configured for selecting a shopping option according to the shopping selection, and saving the shopping option.

In the embodiment of the present application, the shopping option saving unit is configured that, after the smart terminal initiated the corresponding shopping scene according to the parsed result, the user touches the NFC label of the refrigerator, and then initiates the rapid shopping scene of the refrigerator after read and parsed the NFC label successfully. At the same time, the user can select the corresponding product according to the shopping scene of the refrigerator. For example, the user may select 5 L of milk, 10 eggs, and 10 bottles of beer in the shopping option according to the shopping scene of the refrigerator. When the user selects these commodities, it may prompts the user to save the indication, and indicate the user to set a milk option, an egg option and a beer option as the rapid shopping menu option under the shopping scene of the refrigerator. When the user agrees to set the rapid shopping menu option, the shopping option content is saved. When the rapid shopping scene of the refrigerator is initiated next time, the milk option, the egg option and the beer option are automatically loaded in an options menu, so it may be convenient for the user to make the faster shopping selection. When the user selects the setting option of the rapid shopping menu, the smart terminal automatically and simultaneously saves the specific content of the shopping options. The saving mode may be saved in the NFC label, the smart terminal, or the server saving the shopping scene corresponding to the NFC label by the smart terminal, and thus the shopping option content is synchronously saved to facilitate the convenience for the user to use next time.

A shopping selecting unit 46, which is configured for indicating optional commodity service providers according to the final result of the shopping selection.

In the embodiment of the present application, the shopping selecting unit of the shipping unit is configured that, after the user determined a final purchased commodity, the smart terminal completes a confirmation of the shopping selection. At the moment, the smart terminal indicates a subsequent related operation after the shopping selection. For example, the user selects 5 L of milk, 10 eggs, and 10 beers, because the prices, sales, user ratings, shopping discounts and delivery speed of different products in different shopping channels are different, so these information directly affecting a user's decision when purchasing the products may be integrated to display. These information are integrated to display, facilitate the shopping selection made by the user according to these information, and a final selection of the commodity service provider. For example, the optional commodity service providers, such as Jingdong, No. 1 stores, other e-commerce shopping channels, or shopping channels of other physical supermarkets, may be indicated respectively according to the user's selected product. Different shopping channels may display the product prices, sales volume, user ratings, shopping discounts, and delivery speed, and then the user selects the corresponding subsequent operation according to the relevant shopping channels.

An order processing unit 47, which is configured for processing a shopping order according to the optional commodity service provider.

In the embodiment of the present application, the order processing unit of the shopping unit is configured that, after determining the optional commodity service provider, the user may complete an address selection, a payment selection, a mailing time selection, and the like under a specific usage. A plurality of default harvest address may be set for the address selection. Different payment platforms and payment channels may be selected for the payment selection. Preferably, the user needs to enter a payment password when the payment is confirmed. The payment password can protect user's financial security, and it can avoid misoperation resulting in unnecessary economic loss. The smart terminal receives the user's final shopping selection and processes an order according to the user's selection. The alternative smart terminal, after processing the order, may be feedback the processing information of the shopping order and the other subsequent processing information to the user.

In the above method of the embodiment of the present application, a device for rapid shopping is provided as follows: setting a shopping scene corresponding to an NFC label, firstly; then a smart terminal touches the NFC label and reads data content of the NFC label; and then initiates the corresponding shopping scene according to the data content of the NFC label. a rapid shopping selection can be conveniently implemented by using the shopping scene and the shopping option, and finally rapidly completes the purchase of the desired product within the shopping scene; and then the smart terminal processes a follow-up shopping order according to a user's selection, so it is convenient for the user to rapidly procure the commodities according to actual needs. Because of the shopping scene corresponding to the NFC label may be set according to the user's specific usage. The specific shopping option may be a personalized setting based on a user's shopping history, which can greatly facilitate the rapid procurement of a specific commodity for the user under next usage, an improvement of shopping efficiency, but also great convenience for users.

The aforementioned embodiments are only preferred embodiments of the present application, and are not used for limiting the present application. Any modification, equivalent replacement, improvement, and so on, which are made within the spirit and the principle of the present application, should be included in the protection scope of the present application.

What is claimed is:

1. A method for rapid shopping, comprising:
touching an NFC label and reading data content of the NFC label by a smart terminal;
parsing the data content of the NFC label and initiating a shopping scene according to the parsing result by the smart terminal; and
receiving a shopping selection and processing a shopping order according to a final result of the shopping selection by the smart terminal.

2. The method of claim 1, wherein, before the step of touching the NFC label and reading the data content of the NFC label by the smart terminal, the method further comprises:
setting the shopping scene corresponding to the NFC label.

3. The method of claim 2, wherein, after the step of setting the shopping scene corresponding to the NFC label, the method further comprises:
saving the shopping scene corresponding to the NFC label.

4. The method of claim 1, wherein the step of initiating the shopping scene according to the parsing result by the smart terminal comprises:
displaying an application supporting the NFC labels according to the parsing result; and
receiving the application selected by a user, and initiating the shopping scene according to the selected application.

5. The method of claim 1, wherein, after the step of receiving the shopping selection by the smart terminal, the method further comprises:
selecting a shopping option content according to the shopping selection, and saving the shopping option content.

6. The method of claim 1, wherein the step of processing the shopping order according to the final result of the shopping selection comprises:
indicating optional commodity service providers according to the final result of the shopping selection; and
processing the shopping order according to the optional commodity service providers.

7. A device for rapid shopping, wherein the device comprises:
a reading unit configured for a smart terminal to touch an NFC label and read data content of the NFC label;
a parsing unit configured for the smart terminal to parse the data content of the NFC label, and initiate a shopping scene according to a parsing result; and
a shopping unit, configured for the smart terminal to receive a shopping selection, and process a shopping order according to a final result of the shopping selection.

8. The device of claim 7, wherein the device further comprises a scene setting unit configured for setting the shopping scene corresponding to the NFC label.

9. The device of claim 8, wherein the device further comprises a scene saving unit configured for saving the shopping scene corresponding to the NFC label.

10. The device of claim 7, wherein the parsing unit comprises:
a parsing displaying unit, configured for displaying applications supporting the NFC labels according to the parsing result; and
a parsing initiating unit, configured for receiving the applications selected by a user, and initiating the shopping scene according to the selected application.

11. The device of claim 7, wherein the device further comprises a shopping option saving unit, configured for selecting a shopping option content according to the shopping selection, and saving the shopping option content.

12. The device of claim 7, wherein the shopping unit comprises:
a shopping selecting unit, configured for indicating optional commodity service providers according to the final result of the shopping selection; and
an order processing unit, configured for processing a shopping order according to the optional commodity service providers.
